(19) United States
(12) Patent Application Publication
(10) Pub. No.: US 2002/0087749 A1
(43) Pub. Date: Jul. 4, 2002

(54) Computer system, CPU and memory installed apparatus, and input/output control apparatus

(76) Inventor: Koji Tomioka, Tokyo (JP)

Correspondence Address: McGinn & Gibb, PLLC, Suite 200, 8321 Old Courthouse Road, Vienna, VA, 22182-3817, US

(21) Appl. No.: 10/058,264

(22) Filed: Jan. 29, 2002

(30) Foreign Application Priority Data
Jan. 2, 2001 (JP) 2001-025246

(51) Int. Cl. G06F 3/00

(52) U.S. Cl. 710/1

(57) ABSTRACT

CPU and memory installed apparatus 101-1 through 101-3 each having CPU 103 and memory 106 and input/output control apparatus 201-1 through 201-3 are connected to each other by network 301. CPU and memory installed apparatus 101-1 has communication circuit 109 for transmitting an input/output instruction issued by CPU 103 of own CPU and memory installed apparatus to input/output control apparatus 201-1 assigned in advance to the own CPU and memory installed apparatus via network 301, and receiving a response from input/output control apparatus 201-1 via network 301. Input/output control apparatus 201-1 has communication circuit 206 for receiving an input/output instruction from CPU and memory installed apparatus 101-1 assigned in advance to own input/output control apparatus 201-1 via network 301, and transmitting a response to input/output instruction to CPU and memory installed apparatus 101-1 via network 301. When CPU and memory installed apparatus 101-1 suffers a fault and cannot be used, input/output control apparatus 201-1 is assigned to another normal CPU and memory installed apparatus 101-2.

### BACKGROUND OF THE INVENTION

1. Field of the Invention

The present invention relates to a computer system, a CPU and memory installed apparatus and an input/output control apparatus for such a computer system.

2. Description of the Related Art

One conventional computer system is shown in FIG. 1 of the accompanying drawings. As shown in FIG. 1, computer system 1001 comprises four CPUs 1003 and control circuit 1004 which are connected to each other by CPU bus 1002, memory 1005 connected to control circuit 1004 by memory signal line 1011, and two input/output control circuits 1006 connected to control circuit 1004 by input/output signal lines 1012. CPUs 1003, control circuit 1004, memory 1005, and input/output control circuits 1006 are mounted on single board 1013. To input/output control circuits 1006, there are connected peripheral device 1009 via standard input/output buses 1007 like PCI etc. and input/output cards 1008 having a peripheral device control function. Computer system 1001 also has diagnosis control circuit (SP: service processor) 1010 for diagnosing control circuit 1004 and input/output control circuits 1006 for faults and initializing various parts of computer system 1001.

Memory 1005 stores an operating system (OS) and other various application programs. Four CPUs 1003 execute application programs under the control of the single OS to perform various service processes. Memory 1005 also stores various data to be processed. Control circuit 1004 is connected between CPUs 1003, memory 1005, and input/output control circuits 1006 and has a function to transfer memory access instructions and input/output instructions from CPUs 1003 to input/output control circuits 1006 and memory 1005, and a function to transfer responses to those instructions to CPUs 1003. Input/output control circuits 1006 have a function to control peripheral device 1009 via standard input/output buses 1007 and input/output cards 1008 under their own control based on input/output instructions sent from CPUs 1003 via control circuit 1004, and return response data as a result of processing the input/output instructions to CPUs 1003 via control circuit 1004.

Recent computer systems are generally of a clustered arrangement of a plurality of computer systems connected by a network for primarily increasing the availability of the overall system. One conventional clustered computer system is shown in FIG. 2 of the accompanying drawings. The clustered computer system shown in FIG. 2 comprises three conventional computer systems 1001, described above with reference to FIG. 1, which are connected to each other by network 1020. In the arrangement shown in FIG. 2, computer systems 1001 are connected to each other by network 1020 using input/output cards 1021 for network connection. According to another clustered computer system, computer systems 1001 are connected to each other by network via their control circuits 1004.

In the clustered computer system, each of computer systems 1001 operates independently as a single computer under the control of the OS dedicated for its own system, and computer systems 1001 can communicate with each other via network 1020. Therefore, the clustered computer system can perform a variety of job processing events, e.g., by having different jobs performed by different computer systems 1001 or a single job performed concurrently by a plurality of computer systems 1001. The clustered computer system is advantageous in that even when either one of computer systems 1001 goes down, the clustered computer system is in continuous operation with remaining normal computer systems 1001.

One problem of the conventional computer system is that when CPU 1003 or memory 1005 of computer system 1001 fails and cannot be used, even if input/output control circuit 1006 in faulty computer system 1001 is free of any fault and hence is normal, normal input/output control circuit 1006 and peripheral device 1009 under its control cannot be used either. The reasons for this problem are that in conventional computer system 1001, input/output control circuit 1006 can only be controlled from CPU 1003 that is connected thereto through control circuit 1004, and CPU 1003 and input/output control circuit 1006 which carries out input/output instructions issued by CPU 1003 are assembled on same board 1013, which is a minimum unit for maintenance and replacement.

It is therefore an object of the present invention to further increase the availability of a computer system upon a fault thereof.

Ideas about connecting peripheral devices directly connected to one device through a network for sharing those peripheral devices are disclosed in a number of documents including Japanese patent publications of unexamined application No. 2000-141831, No. 2000-172463 and No. 2000-293341, for example. However, there is no document disclosing connecting a CPU and an input/output control circuit exclusively used thereby through a network. One reason is that since network connections are generally intended for sharing devices, it has been considered meaningless to connect a CPU and an input/output control circuit exclusively used thereby through a network. According to another reason, the operating system needs to be modified if an input/output control circuit is connected through a network.

Another object of the present invention is to allow a CPU and an input/output control circuit exclusively used thereby to be connected through a network without any modification of the operating system.

One problem that occurs when a CPU and an input/output control circuit exclusively used thereby are connected through a network is that they may suffer the danger of being operated in error by a wrong access from an unexpected party because they are basically accessible from anywhere on the network.

Still another object of the present invention is to remove the danger of erroneous operation by inhibiting accesses from any parties other than those which have been preset for access, without modifying the operating system.

### SUMMARY OF THE INVENTION

A clustered computer system according to the present invention has a plurality of CPU and memory installed apparatus each having at least one CPU and at least one memory, and a plurality of input/output control apparatus, the CPU and memory installed apparatus and the input/output control apparatus being connected to each other by a network. More specifically, according to a first aspect of the present invention, a computer system comprises a plurality of CPU and memory installed apparatus each having at least one CPU and at least one memory, a plurality of input/output control apparatus, and a network connecting the CPU and memory installed apparatus and the input/output control apparatus to each other, each of the CPU and memory installed apparatus having communication means for transmitting an input/output instruction issued by the CPU of an own CPU and memory installed apparatus to the input/output control apparatus assigned in advance to the own CPU and memory installed apparatus via the network, and receiving a response from the input/output control apparatus via the network, and each of the input/output control apparatus having communication means for receiving an input/output instruction from the CPU and memory installed apparatus assigned in advance to an own input/output control apparatus via the network, and transmitting a response to the input/output instruction to the CPU and memory installed apparatus via the network.

According to a second aspect of the present invention, in the first aspect, the communication means of each of the input/output control apparatus comprises means for receiving an input/output instruction as being effective only when the source of the input/output instruction received via the network is a CPU and memory installed apparatus which has been set in advance.

According to a third aspect of the present invention, in the first or second aspect, the communication means of each of the CPU and memory installed apparatus comprises means for receiving a response as being effective only when the source of the response received via the network is an input/output control apparatus which has been set in advance.

According to a fourth aspect of the present invention, in the first aspect, the network is also used for communications between the plurality of CPU and memory installed apparatus.

According to a fifth aspect of the present invention, in the fourth aspect, the communication means of each of the CPU and memory installed apparatus comprises means for communicating with other CPU and memory installed apparatus via the network.

According to a sixth aspect of the present invention, in the fifth aspect, the communications between the plurality of CPU and memory installed apparatus are communications for accessing memories installed on other CPU and memory installed apparatus.

According to a seventh aspect of the present invention, in the first aspect, the computer system further comprises means for, when either one of the CPU and memory installed apparatus fails to operate due to a fault, assigning the input/output control apparatus which has been used by the faulty CPU and memory installed apparatus to another normal CPU and memory installed apparatus hereby to continue system operation.

According to an eighth aspect of the present invention, in the seventh aspect, an active one of the CPU and memory installed apparatus which is using another input/output control apparatus is used as the other normal CPU and memory installed apparatus.

According to a ninth aspect of the present invention, in the seventh aspect, the computer system further comprises a backup CPU and memory installed apparatus, the backup CPU and memory installed apparatus being used as the other normal CPU and memory installed apparatus.

According to a tenth aspect of the present invention, in the first aspect, the computer system further comprises at least one backup input/output control apparatus, and means for, when either active one of the input/output control apparatus fails to operate due to a fault, assigning the backup input/output control apparatus to the CPU and memory installed apparatus which has been using the faulty input/output control apparatus thereby to continue system operation.

According to an eleventh aspect of the present invention, a computer system comprises a CPU and memory installed apparatus having at least one CPU and at least one memory, an input/output control apparatus, and a communication cable connecting the CPU and memory installed apparatus and the input/output control apparatus to each other, the CPU and memory installed apparatus having communication means for transmitting an input/output instruction issued by the CPU to the input/output control apparatus via the communication cable, and receiving a response from the input/output control apparatus via the communication cable, and the input/output control apparatus having communication means for receiving an input/output instruction from the CPU and memory installed apparatus via the communication cable, and transmitting a response to the input/output instruction to the CPU and memory installed apparatus via the communication cable.

According to another aspect of the present invention, a CPU and memory installed apparatus comprises at least one CPU and at least one memory, communication means for communicating with an external circuit, transmitting an input/output instruction issued by the CPU to an input/output control apparatus which has been assigned in advance, and receiving a response from the input/output control apparatus, and a single board on which the CPU, the memory, and the communication means are mounted.

According to still another aspect of the present invention, in the above CPU and memory installed apparatus, the communication means has means for receiving the response as being effective only when the source of the received response is the input/output control apparatus which has been assigned in advance.

According to yet another aspect of the present invention, an input/output control apparatus comprises an input/output control circuit for controlling a peripheral device based on an input/output instruction, communication means for communicating with an external circuit, receiving an input/output instruction from a CPU and memory installed apparatus which has been set in advance and transferring the input/output instruction to the input/output control circuit, and transmitting a response to the input/output instruction to the CPU and memory installed apparatus.

According to yet still another aspect of the present invention, in the above input/output control apparatus, the communication means has means for receiving the input/output instruction as being effective only when the source of the received input/output instruction is the CPU and memory installed apparatus which has been set in advance.

When the clustered computer system starts operating, address information of the input/output control apparatus used by the CPU and memory installed apparatus is set in the communication means of the CPU and memory installed apparatus, and address information of the CPU and memory installed apparatus using the input/output control apparatus is set in the communication means of the input/output control apparatus. When an input/output instruction is issued from the CPU of the CPU and memory installed apparatus in the startup of operation of the clustered computer system, the input/output instruction is transferred to the communication means, which transmits the input/output instruction via the network to the corresponding input/output control apparatus according to the address information set in the communication means upon starting of operation of the clustered computer system, and the input/output control apparatus controls the peripheral device based on the input/output instruction received by the communication means. The communication means of the input/output control apparatus transmits a response to the input/output instruction to the CPU and memory installed apparatus via the network according to the address information set in the communication means upon starting of operation of the clustered computer system.

In the CPU and memory installed apparatus, since the communication means is responsible for transmitting input/output instructions issued by the CPU to given destinations and receiving responses to the input/output instructions, the CPU issues input/output instructions and receives responses thereto in the same manner as with the conventional computer system, and the input/output control apparatus looks as if directly connected to the CPU. Consequently, the operating system does not need to be modified at all. When a CPU and memory installed apparatus which is currently using a certain input/output control apparatus suffers a fault and becomes unable to be used, a diagnosis control circuit or the like changes the address information in the communication means of the input/output control apparatus to address information of another normal CPU and memory installed apparatus, and sets the address information of the input/output control apparatus in the communication means of the normal CPU and memory installed apparatus. As a result, it becomes possible to use the input/output control apparatus from the normal CPU and memory installed apparatus, thus increasing the availability of the clustered computer system. If a backup input/output control apparatus is available, then when either one of the active input/output control apparatus suffers a fault and cannot be used, the backup input/output control apparatus is assigned to the CPU and memory installed apparatus which has been using the faulty input/output control apparatus, thereby allowing services including the input/output process in the CPU and memory installed apparatus to be continued.

The above objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram of a conventional computer system;

FIG. 2 is a block diagram of another conventional computer system;

FIG. 3 is a block diagram of a CPU and memory installed apparatus for use in a computer system according to the present invention;

FIG. 4 is a diagram schematically showing a converting process carried out by a communication circuit of the CPU and memory installed apparatus and an input/output control apparatus;

FIG. 5 is a block diagram of an arrangement of the communication circuit of the CPU and memory installed apparatus;

FIG. 6 is a block diagram of an input/output control apparatus for use in a computer system according to the present invention;

FIG. 7 is a block diagram of a communication circuit of the input/output control apparatus;

FIG. 8 is a block diagram of a computer system according to the present invention;

FIG. 9 is a block diagram of another computer system according to the present invention;

FIG. 10 is a block diagram of still another computer system according to the present invention;

FIG. 11 is a block diagram of another CPU and memory installed apparatus for use in a computer system according to the present invention;

FIG. 12 is a diagram schematically showing a converting process related to memory accessing, which is carried out by a communication circuit of the CPU and memory installed apparatus;

FIG. 13 is a block diagram of another communication circuit of the CPU and memory installed apparatus; and

FIG. 14 is a block diagram of yet another computer system according to the present invention.

### DETAILED DESCRIPTION OF THE PREFERRED EMBODIMENTS

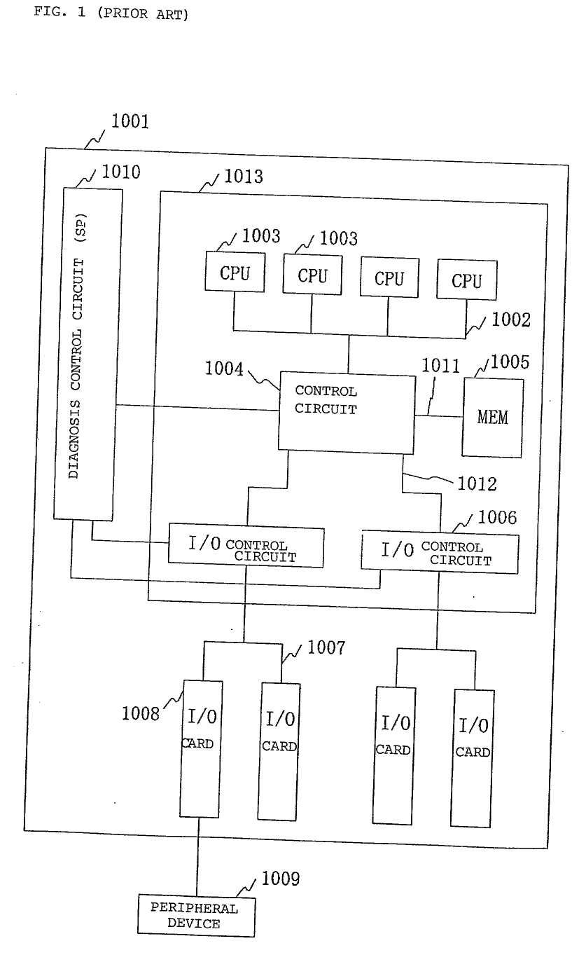

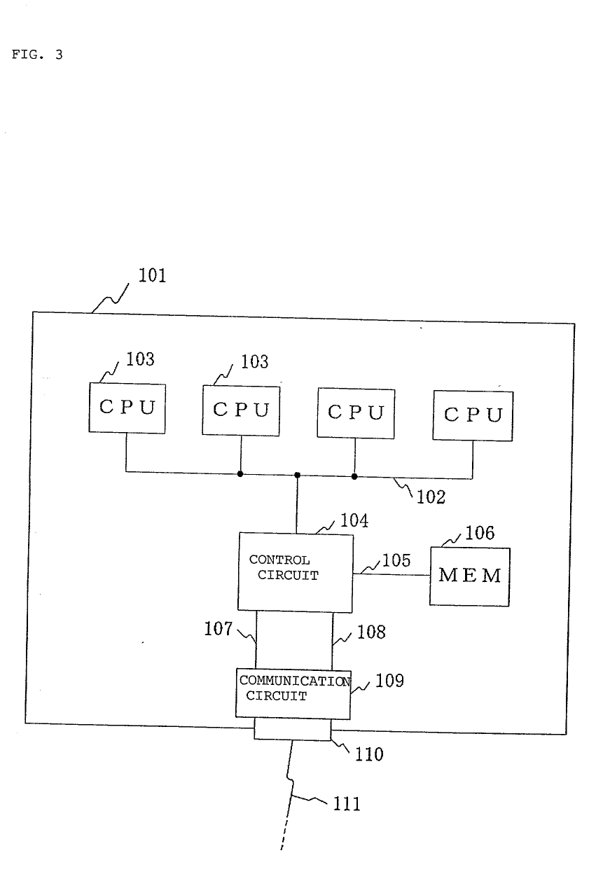

FIG. 3 shows in block form a CPU and memory installed apparatus for use in a computer system according to the present invention. As shown in FIG. 3, CPU and memory installed apparatus 101 comprises four CPUs 103 and control circuit 104 which are connected to each other by CPU bus 102, memory 106 connected to control circuit 104 by memory signal line 105, communication circuit 109 connected to control circuit 104 by two input/output signal lines 107, 108, and a connecting member (e.g., a connector) 110 connected to communication circuit 109 for connection to a communication cable. CPUs 103, control circuit 104, memory 106, and communication circuit 109 are mounted on a single board. In use, communication cable 111 is connected to connecting member 110. Two input/output signal lines 107, 108 are used in order to allow CPU and memory installed apparatus 101 to control two input/output control circuits as with conventional computer system 1001 shown in FIG. 1. Input/output signal line 107 corresponds to an input/output port 0 and input/output signal line 108 to an input/output port 1.

Memory 106 comprises a ROM and a RAM, and stores an operating system (OS), various application programs, and various data to be processed. Four CPUs 103 execute application programs under the control of the OS stored in the memory 106 to perform various service processes. Operation of CPUs 103 to issue input/output instructions and access memory 106 is the same as with the conventional computer system. CPUs 103 output input/output instructions and memory access instructions to CPU bus 102. When CPUs 103 output input/output instructions, one of the input/output ports is designated.

Control circuit 104 performs a control process of interchanging instructions and data between CPUs 103, and, memory 106 and communication circuit 109. In the present embodiment, when an input/output instruction is issued from CPU 103 to CPU bus 102, control circuit 104 reads the input/output instruction and transfers the input/output instruction to communication circuit 109 via one of two input/output signal lines 107, 108 which is connected to a designated input/output port. When control circuit 104 receives a response to the input/output instruction from communication circuit 109 via one of input/output signal lines 107, 108, control circuit 104 transfers the response via CPU bus 102 to CPU 103. When a memory access instruction is issued from CPU 103 to CPU bus 102, control circuit 104 reads the memory access instruction and transfers the memory access instruction via memory signal line 105 to memory 106 to read data from and write data into memory 106. When control circuit 104 receives a response to the memory access instruction to read data, for example, from memory 106 via memory signal line 105, control circuit 104 returns the response via CPU bus 102 to CPU 103.

With conventional computer system 1001 shown in FIG. 1, input/output control circuit 1006 is connected to input/output signal lines 107, 108. According to the present embodiment, however, communication circuit 109 is connected to input/output signal lines 107, 108. Communication circuit 109 has the address information of a destination set therein in advance. Communication circuit 109 has such functions that when communication circuit 109 receives an input/output instruction from input/output signal lines 107, 108, communication circuit 109 outputs a communication message which comprises address information added to the input/output instruction to communication cable 111 connected to connecting member 110, and when communication circuit 109 receives a communication message including a response to the outputted input/output instruction from communication cable 111, communication circuit 109 removes the response and outputs the response to input/output signal lines 107, 108.

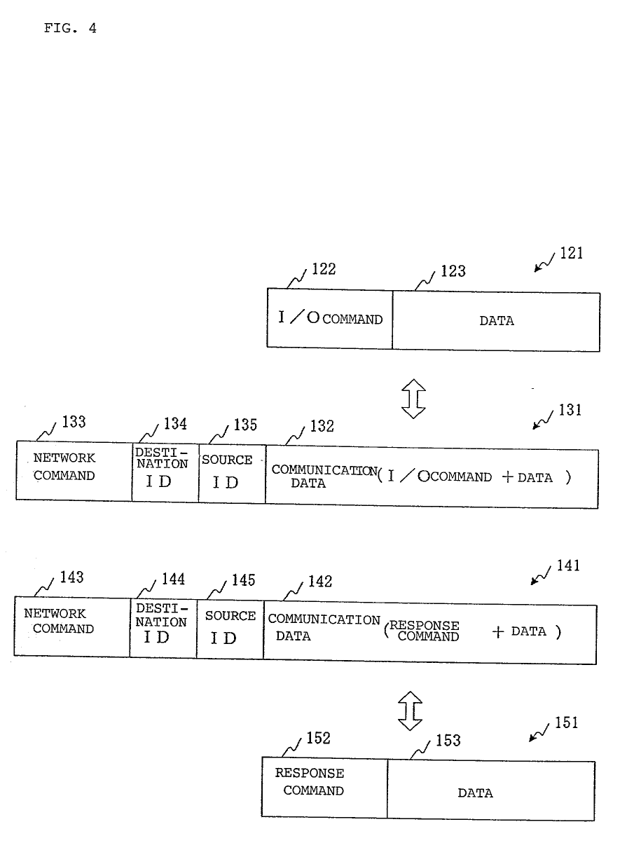

FIG. 4 schematically shows a converting process which is carried out by communication circuit 109. Generally, an input/output instruction issued by CPU 103, and hence an input/output instruction transferred from control circuit 104 through input/output signal lines 107, 108 to communication circuit 109 comprises, as indicated by the reference numeral 121 in FIG. 4, an I/O command 122 indicative of the type of the input/output instruction and data 123 ancillary thereto. Data 123 is generally output data, and therefore an input instruction does not include data 123. When communication circuit 109 receives input/output instruction 121, as indicated by the reference numeral 131 in FIG. 4, communication circuit 109 converts input/output instruction 121 into a communication message including I/O command 122 and data 123 as communication data 132, network command 133, destination ID 134, and source ID 135 which are added to communication data 132, and outputs the communication message to communication cable 111. In destination ID 134 and source ID 135, respective IDs are set in advance. An ID comprises a high-order bit representing a node number and a low-order bit representing an intra-node number. Network command 133 has information representing a message length set therein, and specific details thereof depend on the communication system used.

A communication message received from communication cable 111 comprises, as indicated by the reference numeral 141 in FIG. 4, network command 143, destination command 144, source command 145, and communication data 142. Though received communication message 141 has the same format as communication message 131, communication data 142 includes a response to the input/output instruction that has been issued previously. When communication circuit 109 receives communication message 141, communication circuit 109 extracts communication data 142 from communication message 141, converts communication data 142 into a response of the format indicated by the reference numeral 151 in FIG. 4, and outputs response 151 to input/output signal lines 107, 108. Response 151 comprises response command 152 and data 153 ancillary thereto which are included in communication data 142.

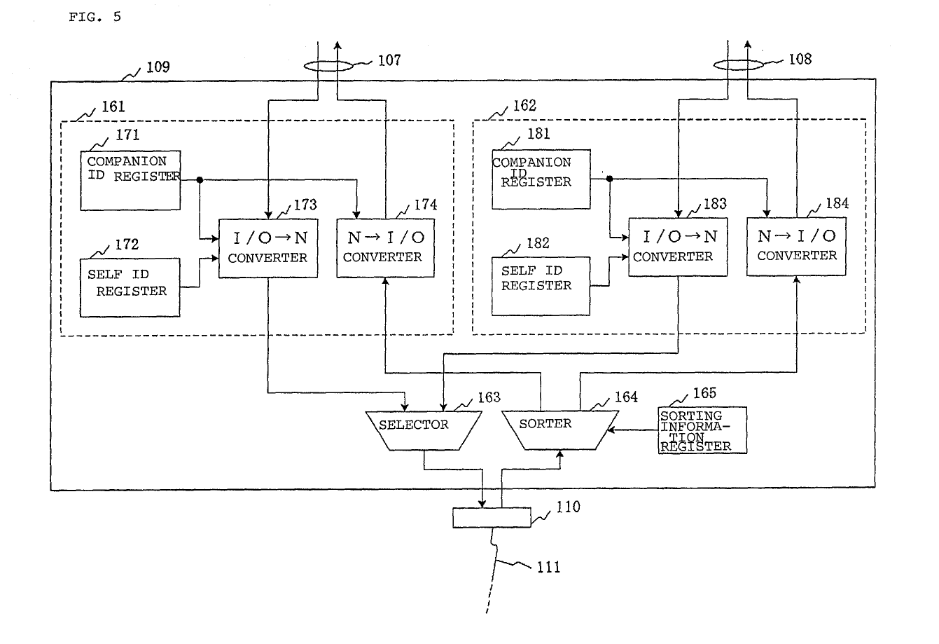

An arrangement of communication circuit 109 which has the above functions is shown in FIG. 5. As shown in FIG. 5, communication circuit 109 comprises converter 161 for port 0 and converter 162 for port 1, which perform the converting process as described above with reference to FIG. 4, selector 163 for successively selecting communication messages generated by respective converters 161, 162 and outputting the selected communication messages to communication cable 111, a sorter 164 for receiving communication messages from communication cable 111 and sorting the communication messages to converter 161 for port 0 and converter 162 for port 1 based on destination IDS 144 of the communication messages, and sorting information register 165 for providing sorter 164 with the values of destination IDS 144 which are to be held by communication messages sorted to converter 161 for port 0 and the values of destination IDS 144 which are to be held by communication messages sorted to converter 162 for port 1.

Converter 161 for port 0 comprises companion ID register 171 for holding an ID for uniquely identifying a communication companion, self ID register 172 for holding an ID for uniquely identifying a communication sender, I/O-to-N converter 173 for, when input/output instruction 121 shown in FIG. 4 is received from input/output signal line 107, generating communication message 131 which comprises input/output instruction 121 set in communication data 132, the set value of companion ID register 171 set in destination ID 134, the set value of self ID register 172 set in source ID 135, and network command 133 added thereto, and outputting communication message 131 to selector 163, and N-to-I/O converter 174 for, when communication message 141 shown in FIG. 4 is received from sorter 164, extracting communication message 142 included in communication message 141 and outputting extracted communication message 142 as response 151 to input/output signal line 107.

Companion ID register 171 has a node number for uniquely identifying an input/output control apparatus used by CPU and memory installed apparatus 101 and an intra-node number for uniquely identifying an input/output control circuit in the input/output control apparatus, set respectively to several high-order bits and several low-order bits. Self ID register 172 has a node number for uniquely identifying CPU and memory installed apparatus 101 and an intra-node number for uniquely identifying input/output port 0 in CPU and memory installed apparatus 101, set respectively to several high-order bits and several low-order bits.

N-to-I/O converter 174 has a function to compare source ID 145 in communication message 141 and the set value of companion ID register 171 with each other and, if the compared values do not agree with each other, not to perform the converting process and hence not to output response 151 to input/output signal line 107. The reason for this function is that, unlike conventional computer system 1001 shown in FIG. 1, CPU and memory installed apparatus 101 according to the present embodiment is basically capable of communicating with all input/output control apparatus connected to the network, but is required to use only an input/output control apparatus set in advance in actual system operation. Therefore, if a response is sent in error from an input/output control apparatus other than the input/output control apparatus set in advance, then a mechanism is needed not to transmit the response as being an error to the CPU. The above checking mechanism of N-to-I/O converter 174 serves such a purpose.

Converter 162 for port 1 comprises elements 181 through 184 which are identical to those of converter 161 for port 0.

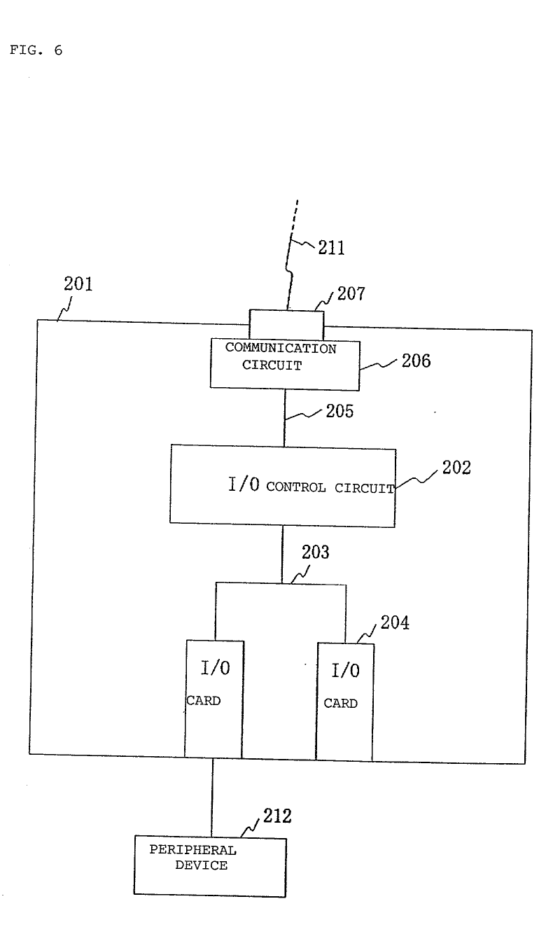

FIG. 6 shows in block form an input/output control apparatus for use in a computer system according to the present invention. As shown in FIG. 6, input/output control apparatus 201 comprises single input/output control circuit 202, a plurality of input/output cards 204 having a peripheral device control function which are connected to input/output control circuit 202 by standard input/output bus 203 such as a PCI or the like, a communication circuit 206 connected to input/output control circuit 202 by input/output signal line 205, and a connecting member (e.g., a connector) 207 connected to communication circuit 206 for connection to a communication cable. Input/output control circuit 202, input/output cards 204, communication circuit 206, and connecting member 206 are mounted on a single board. In use, communication cable 211 is connected to connecting member 207. Peripheral device 212 depending on the type of each input/output card 204 is connected to input/output card 204.

Input/output control circuit 202 has a function to control peripheral device 212 via standard input/output bus 203 and input/output card 204 under its own control based on an input/output instruction received from input/output signal line 205, and outputs a response as a result of processing the input/output instruction to input/output signal line 205. Input/output control circuit 202 is identical in arrangement and operation to input/output control circuit 1006 shown in FIG. 1. In conventional computer system 1001 shown in FIG. 1, control circuit 1004 is connected to input/output signal line 205. In the present embodiment, communication circuit 206 is connected to input/output signal line 205.

Communication circuit 206 has such functions that when communication circuit 206 receives a communication message from communication cable 211, communication circuit 206 removes an input/output instruction from the communication message and outputs the input/output instruction to input/output signal line 205, and when communication circuit 206 receives a response to the input/output instruction from input/output signal line 205, communication circuit 206 outputs a communication message which comprises address information set in advance which is added to the response to communication cable 211. A converting process which is carried out by communication circuit 206 will briefly be described below with reference to FIG. 4.

A communication message received from communication cable 211 is of the format indicated by the reference numeral 131 in FIG. 4. When communication circuit 206 receives communication message 131, communication circuit 206 extracts communication data 132, generates input/output instruction 121 comprising I/o command 122 and data 123 ancillary thereto, and outputs input/output instruction 121 through input/output signal line 205 to input/output control circuit 202. A response outputted from input/output control circuit 202 through input/output signal line 205 is of the format indicated by the reference numeral 151 in FIG. 4. When communication circuit 206 receives response 151, communication circuit 205 converts response 151 into communication message 141 shown in FIG. 4 which comprises response command 152 and data 153 as communication data 142, network command 143, destination command 144, source command 145 which are added to communication data 142, and outputs communication message 141 to communication cable 211. Destination ID 144 and source ID 145 are respective IDs set in advance. Network command 143 has information representing a message length set therein, and specific details thereof depend on the communication system used.

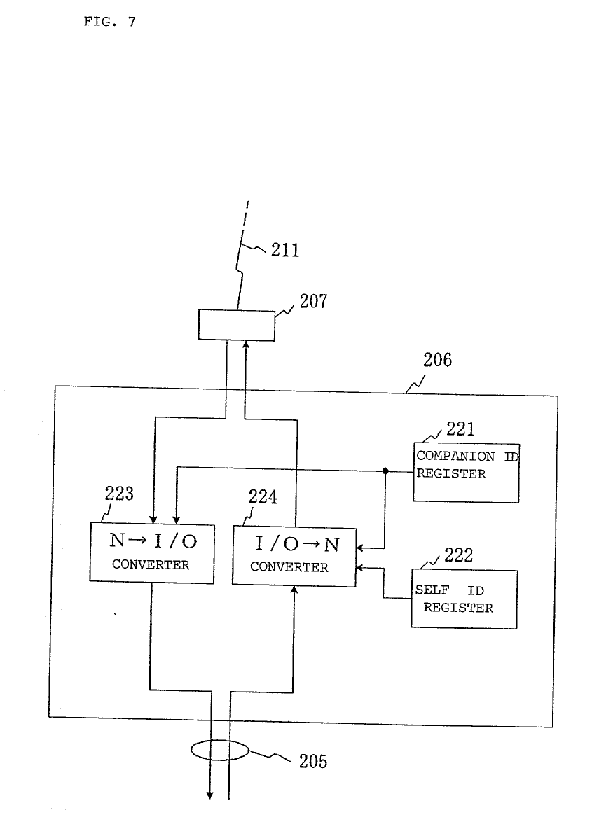

Communication circuit 206 having the above functions can be constructed as with communication circuit 109 of the CPU and memory installed apparatus shown in FIG. 5. Since input/output control apparatus 201 according to the present embodiment has only one input/output control circuit 202, communication circuit 206 may have only one converter corresponding to each of converters 161, 162 shown in FIG. 5. An arrangement of communication circuit 206 is shown in FIG. 7. As shown in FIG. 7, communication circuit 206 comprises companion ID register 221 for holding an ID for uniquely identifying a communication companion, self ID register 222 for holding an ID for uniquely identifying a communication sender, N-to-I/O converter 223 for, when communication message 131 shown in FIG. 4 is received from communication cable 211, extracting communication message 132 included in communication message 131 and outputting extracted communication message 132 as input/output instruction 121 to input/output signal line 205, and I/O-to-N converter 224 for, when response 151 shown in FIG. 4 is received from input/output signal line 205, generating communication message 141 which comprises response 151 set in communication data 142, the set value of companion ID register 221 set in destination ID 144, the set value of self ID register 222 set in source ID 145, and network command 143 added thereto, and outputting communication message 141 to communication cable 211.

Companion ID register 221 has a node number for uniquely identifying a CPU and memory installed apparatus using input/output control apparatus 201 and an intranode number in the CPU and memory installed apparatus, set respectively to a high-order bit and a low-order bit. Self ID register 222 has a node number for uniquely identifying input/output control apparatus 201 and an intranode number for uniquely identifying input/output control circuit 202 in CPU and memory installed apparatus 201, set respectively to several high-order bits and several low-order bits.

N-to-I/O converter 223 has a function to compare source ID 135 in communication message 131 and the set value of companion ID register 221 with each other and, if the compared values do not agree with each other, not to perform the converting process and hence not to output input/output instruction 121 to input/output signal line 205. The reason for this function is that, unlike conventional computer system 1001 shown in FIG. 1, input/output control circuit 201 according to the present embodiment is basically capable of communicating with all CPU and memory installed apparatus connected to the network, but is required to use only a CPU and memory installed apparatus set in advance in actual system operation. Therefore, if a communication message including an input/output instruction is sent in error from a CPU and memory installed apparatus other than the CPU and memory installed apparatus set in advance, then a mechanism is needed not to transmit the communication message as being an error to input/output control circuit 202. The above checking mechanism of N-to-I/O converter 223 serves such a purpose.

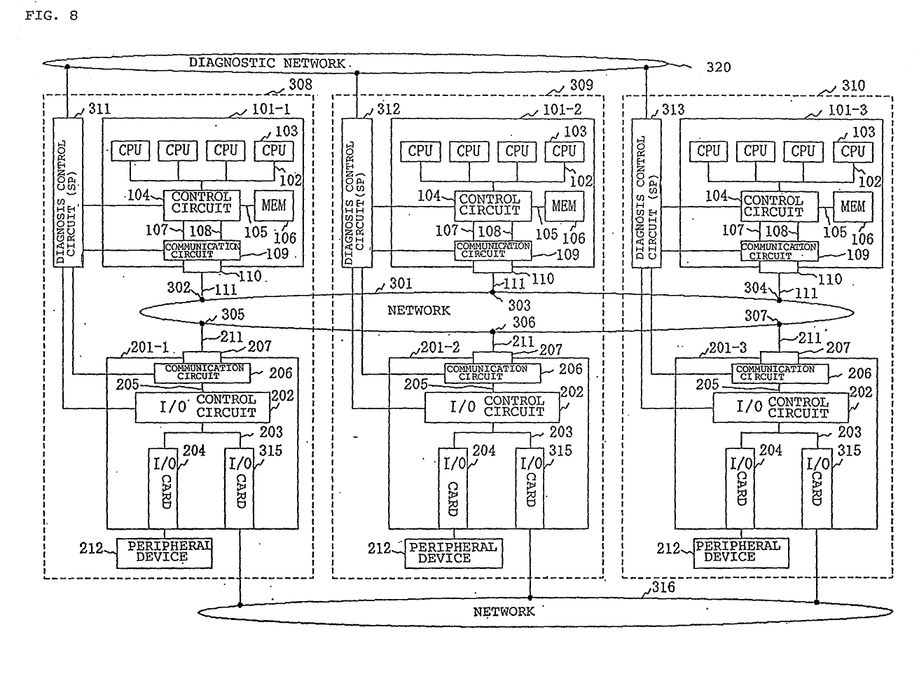

FIG. 8 shows in block form a computer system according to the present invention. The computer system comprises three CPU and memory installed apparatus 101 shown in FIG. 3 and three input/output control apparatus 201 shown in FIG. 6, making up a clustered computer system. In FIG. 8, the CPU and memory installed apparatus and the input/output control apparatus are distinguished from each other by reference numerals 101-1 through 101-3 and 201-1 through 201-3, respectively.

CPU and memory installed apparatus 101-1 through 101-3 are connected to respective junctions 302 through 304 on network 301 by communication cables 111, and input/output control apparatus 201-1 through 201-3 are connected to respective junctions 305 through 307 on network 301 by communication cables 211. Network 301 has node numbers of CPU and memory installed apparatus 101-1 through 101-3 and input/output control apparatus 201-1 through 201-3 which are connected to those junctions, set in advance as address information of junctions 302 through 307. Network 301 sends communication messages 131, 141 flowing in from junctions 302 through 307 to nodes (CPU and memory installed apparatus, input/output control apparatus) connected to the junctions having the same node numbers as the node numbers in destination IDs 134, 144 of communication messages 131, 141. Network 301 may comprise a high-speed network such as a torus network, a mesh network, a crossbar network, or the like.

Since a plurality of CPU and memory installed apparatus 101-1 through 101-3 and a plurality of input/output control apparatus 201-1 through 201-3 are connected to each other by network 301, any desired one of CPU and memory installed apparatus 101-1 through 101-3 is basically capable of controlling any one of input/output control apparatus 201-1 through 201-3. In actual system operation, input/output control apparatus 201-1 through 201-3 are logically assigned to CPU and memory installed apparatus 101-1 through 101-3, jointly making up information processing apparatus. In FIG. 8, input/output control apparatus 201-1 is assigned to CPU and memory installed apparatus 101-1, input/output control apparatus 201-2 to CPU and memory installed apparatus 101-2, and input/output control apparatus 201-3 to CPU and memory installed apparatus 101-3. CPU and memory installed apparatus 101-1 and input/output control apparatus 201-1 make up one information processing apparatus 308, CPU and memory installed apparatus 101-2 and input/output control apparatus 201-2 make up another information processing apparatus 309, and CPU and memory installed apparatus 101-3 and input/output control apparatus 201-3 make up still another information processing apparatus 310.

Input/output control apparatus 201-1 through 201-3 are assigned to CPU and memory installed apparatus 101-1 through 101-3 by setting companion IDs in their communication circuits 109, 206. Specifically, in communication circuit 109 of CPU and memory installed apparatus 101-1, the node number and intra-node number of input/output control apparatus 201-1 are set in companion ID register 171 in converter 161 for port 0 shown in FIG. 5. In communication circuit 206 of input/output control apparatus 201-1, the node number and intra-node number of CPU and memory installed apparatus 101-1 are set in companion ID register 221 shown in FIG. 7. Similarly, the node numbers and intra-node numbers of input/output control apparatus 201-2, 201-3 are set in companion ID registers 171 in converters 161 for port 0 of communication circuits 109 of CPU and memory installed apparatus 101-2, 101-3. The node numbers and intra-node numbers of CPU and memory installed apparatus 101-2, 101-3 are set in companion ID registers 221 in communication circuits 206 of input/output control apparatus 201-2, 201-3. No companion IDS are set in converters 162 for port 1 in communication circuits 109 of CPU and memory installed apparatus 101-1 through 101-3 as these converters 162 are not used at the time of starting to operate the system.

In the computer system according to the present embodiment, the above setting of companion IDs in communication circuits 109, 206 as well as the setting of self IDs in communication circuits 109, 206 and the setting of sorting information are carried out by diagnosis control circuits (SP) 311 through 313 associated respectively with information processing apparatus 308 through 310. Specifically, diagnosis control circuits 311 through 313 have paths to communication circuits 109, 206, and sets companion ID registers 171, 181, self ID registers 172, 182, and sorting information register 165 shown in FIG. 5 and companion ID register 221 and self ID register 222 shown in FIG. 7 through the paths. Diagnosis control circuits 311 through 313 have the same function as diagnosis control circuit 1010 of conventional computer system 1001 shown in FIG. 1, and can communicate with each other through a diagnostic network 320.

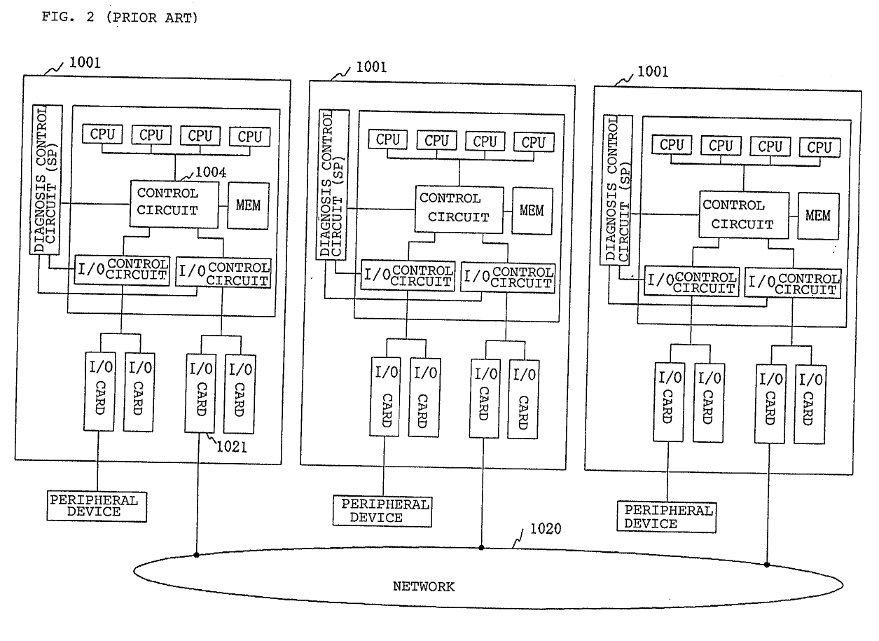

For enabling information processing apparatus 308 through 310 to communicate with each other, information processing apparatus 308 through 310 are connected to each other by input/output cards 315 for network connection in input/output control apparatus 201-1 through 2013 of respective information processing apparatus 308 through 310, as with the conventional computer system shown in FIG. 2. Network 316 may comprise Ethernet, for example. Of course, information processing apparatus 308 through 310 may be connected to each other by a network via control circuits 104 in CPU and memory installed apparatus 101-1 through 101-3 of respective information processing apparatus 308 through 310. Furthermore, network 301 may be used to connect information processing apparatus 308 through 310 to each other, as described later on.

Operation of the computer system according to the present embodiment will be described below.

At the time of starting to operate the computer system shown in FIG. 8, diagnosis control circuits 311 through 313 initialize various parts of the system. Specifically, diagnosis control circuits 311 through 313 set companion IDs, self IDs, and sorting information in communication circuits 109, 206, and also set system configuration information indicating that one of input/output control apparatus 201-1 through 201-3 is connected to input/output port 0 of each of CPU and memory installed apparatus 101-1 through 101-3 and no input/output control apparatus is connected to input/output port 1. CPU 103 of each of CPU and memory installed apparatus 101-1 through 101-3 uses input/output port 0 when it issues an input/output instruction.

When CPU 103 of either one of CPU and memory installed apparatus 101-1 through 101-3 issues an input/output instruction to input/output port 0, control circuit 104 transfers the input/output instruction to communication circuit 109. In communication circuit 109, I/O-to-N converter 173 in converter 161 for port 1 shown in FIG. 5 converts input/output instruction 121 into communication message 131 as shown in FIG. 4, and sends communication message 131 via selector 163, connecting member 110, and communication cable 111 to junction 302 on network 301. At this time, destination ID 134 of communication message 131 represents a node number which uniquely identifies input/output control apparatus 201-1 and an intra-node number which uniquely identifies input/output control circuit 202, and source ID 135 represents a node number which uniquely identifies CPU and memory installed apparatus 101-1 and an intra-node number which uniquely identifies port 0.

Network 301 delivers communication message 131 flowing into junction 302 to junction 305 according to the node number in destination ID 134, from which communication message 131 is sent to input/output control apparatus 201-1. Communication circuit 206 of input/output control apparatus 201-1 receives communication message 131 via communication cable 211 and connecting member 207. If N-to-I/O converter 223 confirms that source ID 135 agrees with the companion ID set in companion ID register 221, then communication circuit 206 converts communication message 131 into original input/output instruction 121 as shown in FIG. 4 and outputs input/output instruction 121 to input/output control circuit 202. Input/output control circuit 202 receives and analyzes input/output instruction 121. If input/output instruction 121 is an input/output instruction relative to peripheral device 212, then input/output control circuit 202 transfers the input/output instruction via input/output card 204 to peripheral device 212. Peripheral device 212 analyzes and carries out the input/output instruction, and returns a result to input/output control circuit 202. If input/output instruction 121 is an input/output instruction relative to communications with another information processing apparatus via network 316, then input/output control circuit 202 transfers the input/output instruction to input/output card 315, which analyzes the input/output instruction, communicates with the information processing apparatus via network 316, and returns a result to input/output control circuit 202.

Input/output control circuit 202 transmits the returned result as a response to the input/output instruction to communication circuit 206. In communication circuit 206, I/O-to-N converter 224 shown in FIG. 7 converts response 151 into communication message 141 as shown in FIG. 4, and sends communication message 141 to junction 305 on network 301. At this time, destination ID 144 of communication message 141 represents a node number which uniquely identifies CPU and memory installed apparatus 101-1 and an intra-node number which uniquely identifies port 0, and source ID 145 represents a node number which uniquely identifies input/output control apparatus 201-1 and an intra-node number which uniquely identifies input/output control circuit 202.

Network 301 delivers communication message 141 flowing into junction 305 to junction 302 according to the node number in destination ID 144, from which communication message 141 is sent to CPU and memory installed apparatus 101-1. In communication circuit 109 of CPU and memory installed apparatus 101-1, sorter 164 receives communication message 141 via communication cable 111 in FIG. 5 and connecting member 110, and sorts communication message 141 to converter 161 for port 0 based on destination ID 144 of communication message 141 and sorting information in sorting information register 165. In converter 161, N-to-I/O converter 174 confirms that source ID 145 agrees with the companion ID set in companion ID register 171. Converter 161 converts communication message 141 into original response 151 as shown in FIG. 4 and outputs response 151 to control circuit 104. Control circuit 104 sends response 151 to CPU 103.

The same operation as described above is carried out when input/output instructions are issued from CPUs 103 of CPU and memory installed apparatus 101-2, 101-3. However, an input/output instruction issued from CPU and memory installed apparatus 101-2 is transmitted via network 301 to input/output control apparatus 201-2 and processed thereby, and an input/output instruction issued from CPU and memory installed apparatus 101-3 is transmitted via network 301 to input/output control apparatus 201-3 and processed thereby.

If either one of CPU and memory installed apparatus 101-1 through 101-3 suffers a fault and cannot continuously be operated while the system is in operation, then input/output control apparatus 201-1 which has been used thereby fails to operate because no apparatus issues an input/output instruction thereto even though input/output control apparatus 201-1 itself is not faulty. When diagnosis control circuit 311 detects such a state, it cooperates with other diagnosis control circuits 312, 313 in effectively utilizing normal input/output control apparatus 201-1. First, diagnosis control circuit 311 determines a CPU and memory installed apparatus which will newly use input/output control apparatus 201-1. Specifically, diagnosis control circuit 311 may determine a CPU and memory installed apparatus based on the information set in advance in diagnosis control circuits 311 through 313 that indicates which other CPU and memory installed apparatus will take over the input/output control apparatus which has been used by a CPU and memory installed apparatus when the latter CPU and memory installed apparatus becomes faulty, or based on negotiations made with the other diagnosis control circuits. It is assumed below that CPU and memory installed apparatus 101-2 is determined as using input/output control apparatus 201-1.

When CPU and memory installed apparatus 101-2 is determined as a new user of input/output control apparatus 201-1, then diagnosis control circuit 311 restarts input/output control apparatus 201-1. Specifically, diagnosis control circuit 311 sets the node number of CPU and memory installed apparatus 101-2 and the intra-node number indicative of port 1 in companion ID register 221, shown in FIG. 7, of communication circuit 206, and also sets the original IDs in self ID register 222.

When any process that is being carried out by CPU and memory installed apparatus 312 and input/output control apparatus 201-2 is finished, diagnosis control circuit 312 associated with CPU and memory installed apparatus 101-2 restarts information processing apparatus 309. Specifically, diagnosis control circuit 312 sets the node number and intra-node number of input/output control apparatus 201-1 in companion ID register 181 in converter 162 for port 1, shown in FIG. 5, of communication circuit 109, and sets the node number of CPU and memory installed apparatus 201-1 and the intra-node number indicative of port 1 in self ID register 182. Diagnosis control circuit 312 also sets desired sorting information in sorting information register 165 for sorting a communication message to converter 161 for port 0 if the intra-node number of destination ID 144 in the communication message indicates port 0, and sorting a communication message to converter 162 for port 1 if the intra-node number of destination ID 144 in the communication message indicates port 1. Diagnosis control circuit 312 sets the original IDs in companion ID register 171 and self ID register 172 of converter 161 for port 0, and companion ID register 221 and self ID register 222 in communication circuit 206 of input/output control apparatus 201-2. Furthermore, diagnosis control circuit 312 sets system configuration information indicating that input/output control apparatus 201-1 connected to input/output port 0 of CPU and memory installed apparatus 101-2 and input/output control apparatus 201-1 is connected to input/output port 1. Therefore, CPU 103 of CPU and memory installed apparatus 101-2 can use both input/output port 0 and input/output port 1 when it issues an input/output instruction.

When system operation is subsequently resumed and CPU 103 of CPU and memory installed apparatus 101-2 issues an input/output instruction to input/output port 1, converter 162 for port 1 in communication circuit 109 converts the input/output instruction into a communication message to which a destination ID including the node number of input/output control apparatus 201-1 is added, and sends the communication message via network 301 to input/output control apparatus 201-1. A response from input/output control apparatus 201-1 is converted by communication circuit 206 into a communication message to which a destination ID including the node number of CPU and memory installed apparatus 101-2 and the intra-node number indicative of port 1 are added, and the communication message is sent via network 301 to CPU and memory installed apparatus 101-2. Converter 162 for port 1 in communication circuit 109 converts the communication message into the original response, which is then transmitted to CPU 103.

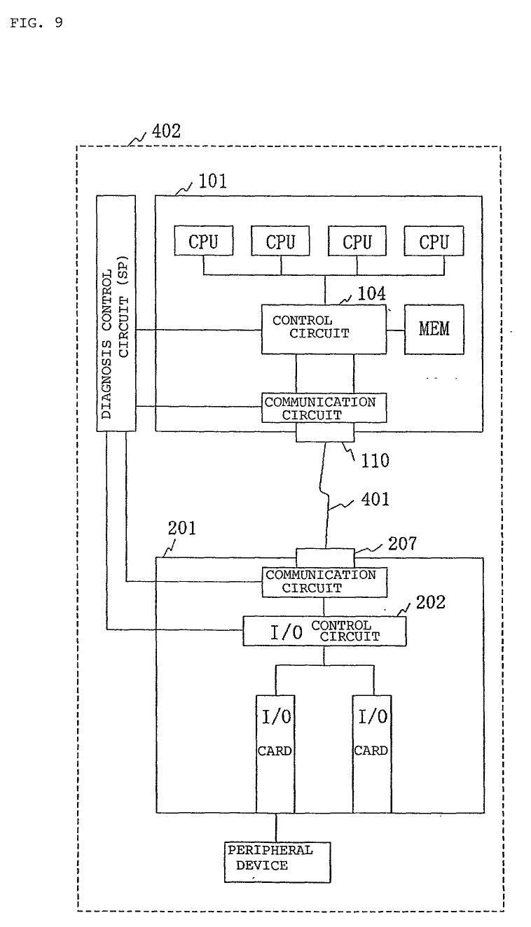

FIG. 9 shows in block form another computer system according to the present invention. The computer system shown in FIG. 9 comprises one CPU and memory installed apparatus 101 shown in FIG. 3 and one input/output control apparatus 201 shown in FIG. 6, with their connecting members 110, 207 being directly connected to each other by communication cable 401, thereby making up information processing apparatus 402 of minimum configuration which has a single CPU and memory installed apparatus and a single input/output control apparatus.

Information processing apparatus 402 of minimum configuration is poorer than cluster-type information processing apparatus in terms of performance and availability, but is frequently used for small-scale information processing as it is inexpensive. Since CPU and memory installed apparatus 101 and input/output control apparatus 201 are held in one-to-one correspondence, control circuit 104 and input/output control circuit 202 might otherwise be directly connected to each other. However, information processing apparatus 402 is advantageous in that since the CPU and memory installed apparatus and the input/output control apparatus used in the clustered computer system shown in FIG. 8 can be used as they are, any designs dedicated for minimum configuration are not required and the number of parts used is reduced. Information processing apparatus 402 is also advantageous in that when its processing capability runs short, a CPU and memory installed apparatus and an input/output control apparatus may be purchased and added to reconstruct a clustered computer system as shown in FIG. 8.

Operation of information processing apparatus 402 shown in FIG. 9 is the same as the operation of the computer system shown in FIG. 8 except that communication messages are directly exchanged between CPU and memory installed apparatus 101 and input/output control apparatus 201 via communication cable 401, rather than a network.

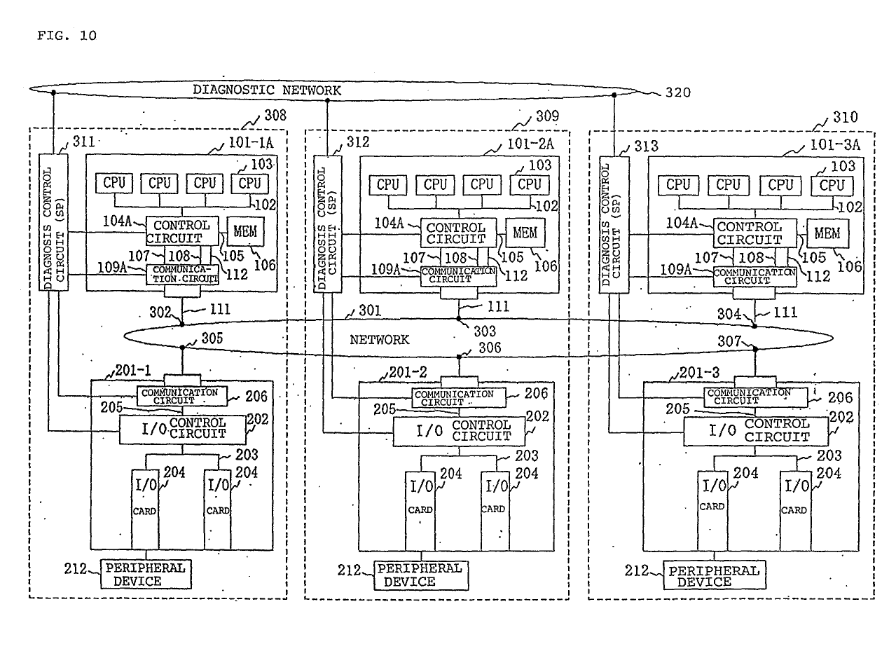

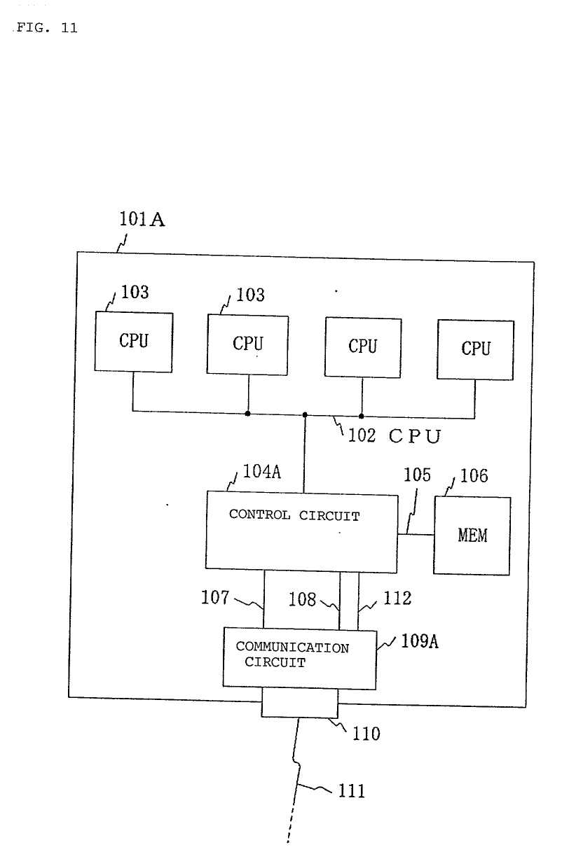

FIG. 10 shows in block form still another computer system according to the present invention. The computer system shown in FIG. 10 is a modification of the computer system shown in FIG. 8 in that communications between CPU and memory installed apparatus 101-1 through 101-3 are not performed through network 316, but through network 301 which interconnects CPU and memory installed apparatus 101-1 through 101-3 and input/output control apparatus 201-1 through 201-3. For performing such communications via network 301, the computer system shown in FIG. 10 uses CPU and memory installed apparatus 101A shown in FIG. 11, rather than CPU and memory installed apparatus 101 shown in FIG. 3.

CPU and memory installed apparatus lOlA shown in FIG. 11 differs from CPU and memory installed apparatus 101 shown in FIG. 3 with respect to the functions of control circuit 104A and communication circuit 109A and in that new inter-node communication path 112 is provided between control circuit 104A and communication circuit 109A.

When CPU 103 issues a memory access instruction to CPU bus 102, control circuit 104A determines whether a memory to be accessed is memory 106 on its own node or a memory on another node based on the access address. If the memory to be accessed is memory 106 on its own node, then control circuit 104A transfers the memory access instruction to memory 106 on its own node via memory signal line 105 in the same manner as with control circuit 104 shown in FIG. 3. If the memory to be accessed is a memory on another node, then control circuit 104A transfers the memory access instruction to communication circuit 109A via inter-node communication path 112. Control circuit 104A can determine whether a memory to be accessed is memory 106 on its own node or a memory on another node based on the access address by associating several high-order bits of the memory address with the node number, judging that the memory access is an access to memory 106 on its own node if the high-order bits are equal to the node number of its own node, and judging that the memory access is an access to a memory on a node corresponding to the node number indicated by the high-order bits. When control circuit 104A receives a response to the memory access instruction from communication circuit 109A via inter-node communication path 112, control circuit 104A transfers the response to CPU 103. Furthermore, when control circuit 104A receives a memory access instruction issued by another node from communication circuit 109A via inter-node communication path 112, control circuit 104A sends the memory access instruction via memory signal line 105 to memory 106 to access memory 106, and transfers a result of the memory access to communication circuit 109A via inter-node communication path 112. Other functions of control circuit 104A are the same as those of control circuit 104 shown in FIG. 3.

In addition to the functions of communication circuit 109 shown in FIG. 3, communication circuit 109A has such functions that when it receives a memory access instruction from inter-node communication path 112, communication circuit 109A generates a communication message directed to its own node which includes the memory access instruction, and outputs the generated communication message, when communication circuit 109A receives a communication message including a response to the memory access instruction from communication cable 111, it removes the response from the communication message and outputs the response to inter-node communication path 112, when communication circuit 109A receives a communication message including a memory access instruction issued by another node from communication cable 111, it removes the memory access instruction from the communication message and outputs the memory access instruction to inter-node communication path 112, and when communication circuit 109A receives a response to the memory access instruction from communication cable 111, it generates a communication message directed to its own node which includes the response and outputs the communication message to communication cable 111.

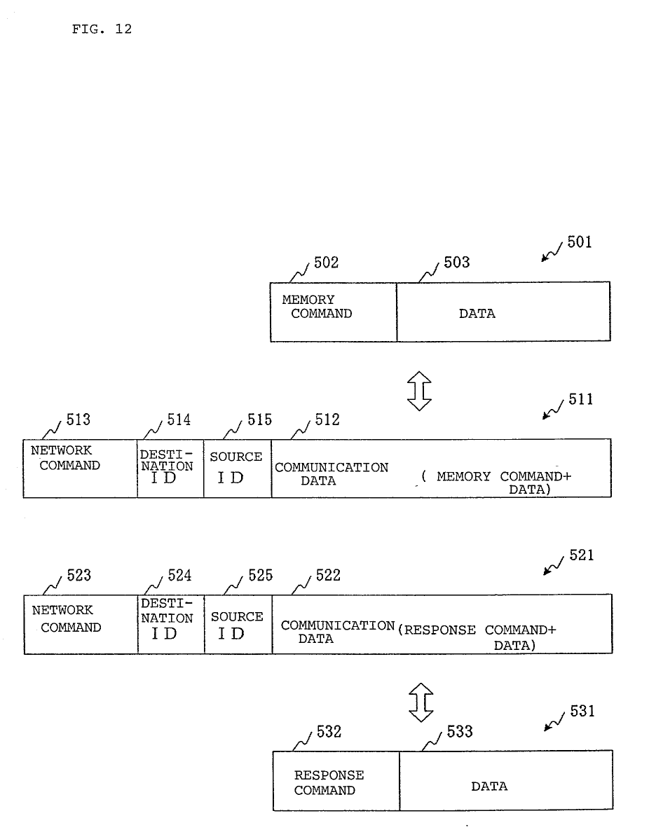

FIG. 12 schematically shows a converting process which is carried out by communication circuit 109A. Generally, a memory access instruction issued by CPU 103, and hence a memory access instruction transferred from control circuit 104A through inter-node communication path 112 to communication circuit 109A comprises, as indicated by the reference numeral 501 in FIG. 12, a memory command 502 indicative of the type of the memory access such as a read access or a write access, and data 503 ancillary thereto. Data 503 is generally write data, and therefore a read instruction does not include data 503. When communication circuit 109A receives memory access instruction 501, as indicated by the reference numeral 5111 in FIG. 12, communication circuit 109A converts memory access instruction 501 into a communication message including memory command 502 and data 503 as communication data 512, network command 513, destination ID 514, and source ID 515 which are added to communication data 512, and outputs the communication message to communication table 111. Destination ID 514 has the node number and intra-node number, set therein, of a node to which the memory access instruction is sent, and source ID 515 has the node number and intra-node number, set therein, of its own node.

A communication message with respect to a memory access instruction returned from the accessed node comprises network command 523, destination ID 524, source ID 525, and communication data 522, as indicated by the reference numeral 521 in FIG. 12. Though communication message 521 has the same format as communication message 511, communication data 522 includes a response to the memory access instruction that has been issued previously. When communication circuit 109A receives communication message 521, communication circuit 109A extracts communication data 522 from communication message 521, converts communication data 522 into a response of the format indicated by the reference numeral 531 in FIG. 12, and outputs response 531 to inter-node communication path 112. Response 531 comprises response command 532 and data 533 ancillary thereto which are included in communication data 521.

A communication message including a memory access instruction sent from another node is of the same format as communication message 511 shown in FIG. 12. When communication circuit 109A receives the communication message, communication circuit 109A converts the communication message into memory access instruction 501, and outputs memory access instruction 501 to inter-node communication path 112. A response received from inter-node communication path 112 in response to memory access instruction 501 is of the same format as response 531 shown in FIG. 12. When communication circuit 109A receives the response, communication circuit 109A converts the response into communication message 521, and outputs communication message 521 to communication cable 111.

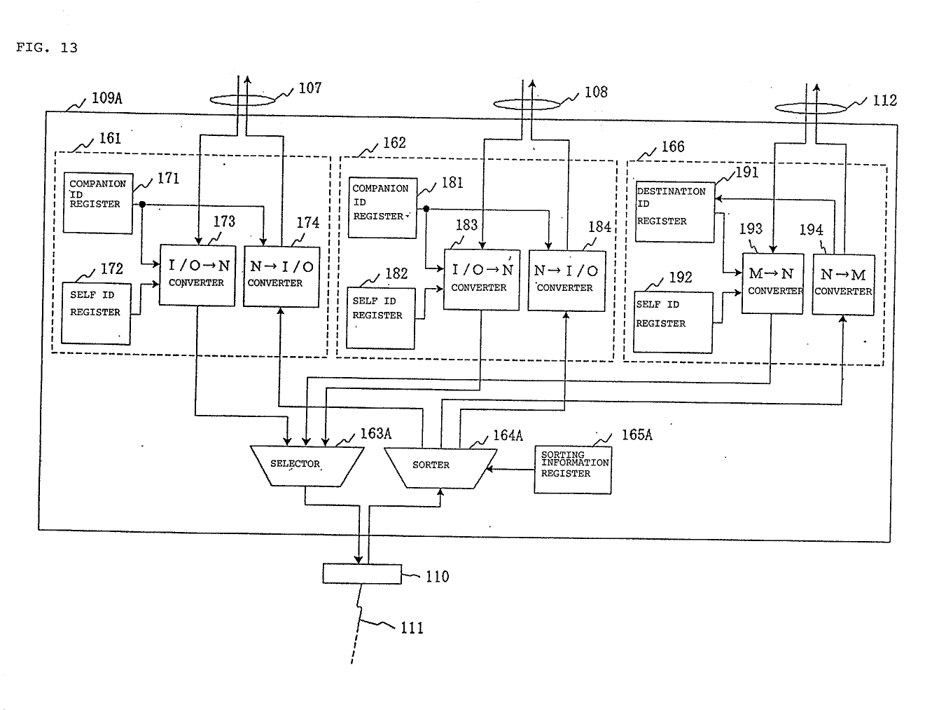

An arrangement of communication circuit 109A which has the above functions is shown in FIG. 13. Communication circuit 109A differs from communication circuit 1009 shown in FIG. 5 in that it has converter 166 for memory access, selector 163A and sorter 164A have expanded functions because of three converters 161, 162, 163, and sorting information of communication messages for converter 166 is added to sorting information register 165.

Converter 166 for memory access comprises destination ID register 191, self ID register 192, an M-to-N converter 193, and an N-to-M converter 194. When M-to-N converter 193 receives memory access instruction 501 shown in FIG. 12 which is outputted from its own CPU from inter-node communication path 112, M-to-N converter 193 converts memory access instruction 501 into communication message 511 shown in FIG. 12, and outputs communication message 511 via selector 163A to communication cable 111. M-to-N converter 193 sets a node number determined from the memory address of memory access instruction 501 and an intra-node number indicative of a converter for memory access in destination ID 512 of communication message 511, and sets its own node number set previously in self ID register 192 and an intra-node number indicative of converter 166 in source ID 515. When N-to-M converter 194 receives communication message 521 shown in FIG. 12 which is sent from another node from sorter 164A, N-to-M converter 194 converts communication message 521 into memory access instruction 531 shown in FIG. 12 and outputs memory access instruction 531 to inter-node communication path 112.

When N-to-M converter 194 receives communication message 511 shown in FIG. 12 which is sent from another node from sorter 164A, N-to-M converter 194 converts communication message 511 into memory access instruction 501 shown in FIG. 12 and outputs memory access instruction 501 to inter-node communication path 112. At this time, source ID 515 of communication message 511 is stored as a destination ID to which a response to the memory access instruction is to be returned in destination ID register 191. When M-to-N converter 193 receives a response to the memory access instruction from inter-node communication path 112, M-to-N converter 193 generates communication message 521 from response 531 shown in FIG. 12, with a destination ID stored in destination ID register 191 being set in its destination ID 524.

The computer system according to the present embodiment performs communications between CPU and memory installed apparatus 101-1A through 101-3A through network 301 which interconnects a plurality of CPU and memory installed apparatus 101-1A through 101-3A and a plurality of input/output control apparatus 201-1 through 201-3 as shown in FIG. 10. Therefore, the computer system is capable of effectively utilizing resources of network 301.

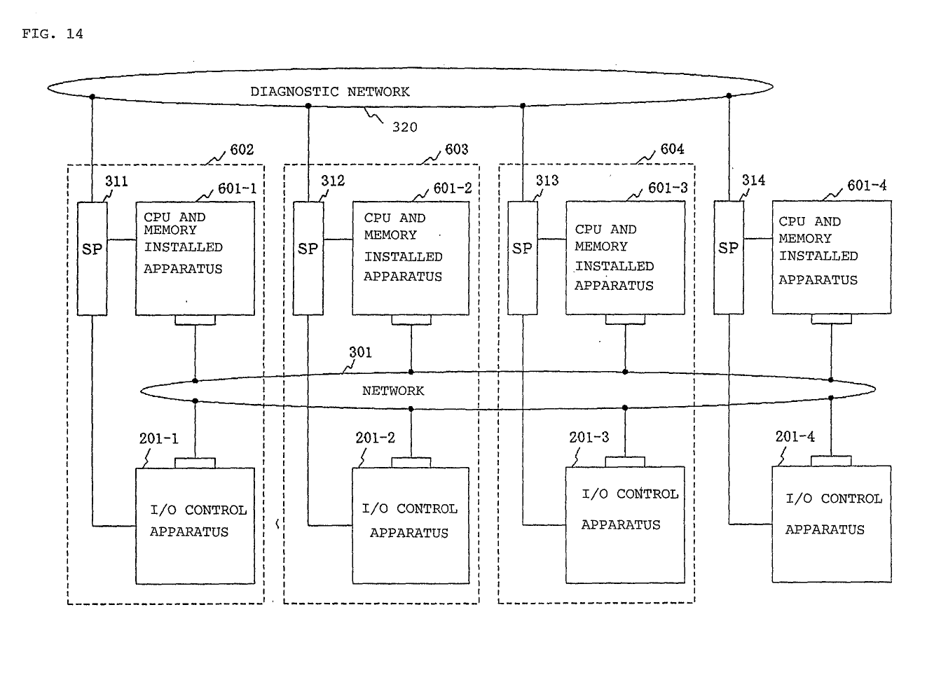

FIG. 14 shows in block form yet another computer system according to the present invention. The computer system shown in FIG. 14 employs three CPU and memory installed apparatus 601-1 through 601-3, each identical to CPU and memory installed apparatus 101 shown in FIG. 3 or lOlA shown in FIG. 11, and three input/output control apparatus 201-1 through 201-3, each identical to in46 put/output control apparatus 201 shown in FIG. 6, making up a clustered computer system having three information processing apparatus 602 through 604, as with the system shown in FIG. 8 or FIG. 10. One CPU and memory installed apparatus 601-4 which is identical to CPU and memory installed apparatus 601-1 through 601-3 and one input/output control apparatus 201-4 which is identical to input/output control apparatus 201-1 through 201-3 are connected in advance as backup apparatus to network 320. Diagnosis control apparatus 314 is connected to backup CPU and memory installed apparatus 601-4 and backup input/output control apparatus 201-4. Diagnosis control apparatus 314 and other diagnosis control apparatus 311 through 313 are connected to diagnostic network 320.

In the above computer system, CPU and memory installed apparatus 601-4 is not used in normal system operation, but is provided as a backup apparatus. When any one of CPU and memory installed apparatus 601-1 through 601-3 which are active apparatus suffers a fault and fails to operate, backup CPU and memory installed apparatus 601-4 takes over the input/output control apparatus which has been used by the faulty CPU and memory installed apparatus, and continues its operation. For example, if CPU and memory installed apparatus 601-1 fails to operate, diagnosis control apparatus 311 resets the companion ID of communication circuit 206 in input/output control apparatus 201-1 to the ID of CPU and memory installed apparatus 601-4. Diagnosis control apparatus 314 starts to operate CPU and memory installed apparatus 6014. At this time, diagnosis control apparatus 314 performs an initializing process by setting the companion ID in converter 161 for port 0 of communication circuit 109 or 109A of CPU and memory installed apparatus 601-4 to the ID of input/output control apparatus 201-1, and the service processing carried out by CPU and memory installed apparatus 601-1 is resumed by CPU and memory installed apparatus 601-4 using input/output control apparatus 201-1.

Input/output control apparatus 201-4 is not used in normal system operation, but is provided as a backup apparatus. When any one of input/output control apparatus 201-1 through 201-3 which are active apparatus suffers a fault and fails to operate, backup input/output control apparatus 201-4 is assigned to the CPU and memory installed apparatus which has used the faulty input/output control apparatus, and continues its operation. For example, if input/output control apparatus 201-1 fails to operate, diagnosis control apparatus 311 performs an initializing process by setting the companion ID in converter 161 for port 0 of communication circuit 109 or 109A to the ID of input/output control apparatus 201-4 when CPU and memory installed apparatus 601-1 is re-started. Diagnosis control apparatus 314 sets the companion ID of communication circuit 206 of put/output control apparatus 201-1 to the ID of CPU and memory installed apparatus 601-1, and the service carried out using input/output control apparatus 201-1 is resumed by CPU and memory installed apparatus 601-1 using input/output control apparatus 201-4.

While the present invention has been described with respect to several embodiments, the present invention is not limited to the illustrated embodiments, but various additions and modifications may be made as described below.

Through the CPU and memory installed apparatus has four CCPU 103 in the illustrated embodiments, it may have three or less CPUs insofar as it has at least one CPU.

In the CPU and memory installed apparatus, CPUs 103 are connected to control circuit 104 via CPU bus 102. However, CPUs 103 may be connected to control circuit 104 via individual signal lines, or CPUs 103, memory 106, control circuit 104, and communication circuit 109 may be connected to each other by a common bus.

In the illustrated embodiments, the CPU and memory installed apparatus is arranged such that up to two input/output control apparatus are connected to the CPU and memory installed apparatus. However, the CPU and memory installed apparatus may be arranged such that three or more input/output control apparatus can be connected to the CPU and memory installed apparatus, or only one input/output control apparatus can be connected to the CPU and memory installed apparatus.

While the input/output control apparatus has only one input/output control circuit 202 in the illustrated embodiments, the input/output control apparatus may have two or more input/output control circuits. In such a modification, communication circuit 206 has as many companion ID registers 221, self ID registers 222, N-to-I/O converters 223, and I/O-to-N converters 224, shown in FIG. 7, as the number of input/output control circuits used, and also has selector 163, sorter 164, and sorting information register 165 which are identical to those of communication circuit 109.

In normal system operation, only one input/output control apparatus is assigned to one CPU and memory installed apparatus. In normal system operation, however, a plurality of input/output control apparatus may be assigned to one CPU and memory installed apparatus.

The computer system of minimum configuration shown in FIG. 9 employs CPU and memory installed apparatus 101 shown in FIG. 3. However, the computer system of minimum configuration shown in FIG. 9 may employ CPU and memory installed apparatus 101A shown in FIG. 11.

According to the converting process carried out by communication circuit 109 as shown in FIG. 4, I/O command 122 and data 123 are converted so as to be included as they are in communication data 132. However, by defining a network command in one-to-one correspondence to an I/O command, the I/O command and the network command may be integrated with each other, or data itself may be compressed and sent as network data. In the illustrated embodiments, a high-order bit and a low-order bit are set as a destination ID and a source ID for uniquely identifying node numbers and input/output ports. However, any numbers capable of uniquely determining input/output ports throughout the system. For example, successive values may be used to determine respective input/output ports, or any desired unique values may be used to determine respective input/output ports.

The present invention described above offers the following advantages:

The availability of the computer system can be increased when the computer system suffers a fault. The reasons for the increased availability are as follows: With the conventional computer system, when a CPU and a memory suffer a fault and cannot be used, an input/output control apparatus connected directly thereto cannot be used either even if it is normal. According to the present invention, CPU and memory installed apparatus and input/output control apparatus are separate from each other, and input/output control apparatus can be used with other CPU and memory installed apparatus. With the conventional computer system, when an input/output control apparatus suffers a fault and cannot be used, a CPU and a memory connected directly thereto cannot be used even if they are normal unless they have another input/output control apparatus. According to the present invention, a backup input/output control apparatus is assigned to the CPU and memory installed apparatus to allow the CPU and memory installed apparatus to be used.

The operating system of the computer system does not need to be modified. The reasons for this are that since the communication means is responsible for transmitting input/output instructions issued by the CPU to given destinations and receiving responses to the input/output instructions, the CPU issues input/output instructions and receives responses thereto in the same manner as with the conventional computer system, and the input/output control apparatus looks as if directly connected to the CPU.

Erroneous operations that would be caused by communications from unexpected parties, which would pose problems when connected to a network, can be prevented. The reasons for this are that the communication means of the input/output control apparatus has means for receiving an input/output instruction as being effective only when the source of the input/output instruction received via the network is a CPU and memory installed apparatus that has been set in advance, and that the communication means of the CPU and memory installed apparatus has means for receiving a response as being effective only when the source of the response received via the network is an input/output control apparatus that has been set in advance.

Although certain preferred embodiments of the present invention have been shown and described in detail, it should be understood that various changes and modifications may be made therein without departing from the scope of the appended claims.

What is claimed is:

1. A clustered computer system comprising a plurality of CPU and memory installed apparatus each having at least one CPU and at least one memory, and a plurality of input/output control apparatus, said CPU and memory installed apparatus and said input/output control apparatus being connected to each other by a network.

2. A computer system comprising a plurality of CPU and memory installed apparatus each having at least one CPU and at least one memory, a plurality of input/output control apparatus, and a network connecting said CPU and memory installed apparatus and said input/output control apparatus to each other, each of said CPU and memory installed apparatus having communication means for transmitting an input/output instruction issued by said CPU of an own CPU and memory installed apparatus to said input/output control apparatus assigned in advance to the own CPU and memory installed apparatus via said network, and receiving a response from said input/output control apparatus via said network, and each of said input/output control apparatus having communication means for receiving an input/output instruction from said CPU and memory installed apparatus assigned in advance to an own input/output control apparatus via said network, and transmitting a response to said input/output instruction to said CPU and memory installed apparatus via said network.

3. A computer system according to claim 2, wherein said communication means of each of said input/output control apparatus comprises means for receiving an input/output instruction as being effective only when the source of the input/output instruction received via said network is a CPU and memory installed apparatus which has been set in advance.

4. A computer system according to claim 2, wherein said communication means of each of said CPU and memory installed apparatus comprises means for receiving a response as being effective only when the source of the response received via said network is an input/output control apparatus which has been set in advance.

5. A computer system according to claim 2, wherein said network is also used for communications between said plurality of CPU and memory installed apparatus.

6. A computer system according to claim 3, wherein said communication means of each of said CPU and memory installed apparatus comprises means for receiving a response as being effective only when the source of the response received via said network is an input/output control apparatus which has been set in advance.

7. A computer system according to claim 5, wherein said communication means of each of said CPU and memory installed apparatus comprises means for communicating with other CPU and memory installed apparatus via said network.

8. A computer system according to claim 7, wherein the communications between said plurality of CPU and memory installed apparatus are communications for accessing memories installed on other CPU and memory installed apparatus.

9. A computer system according to claim 2, further comprising means for, when either one of said CPU and memory installed apparatus fails to operate due to a fault, assigning said input/output control apparatus which has been used by the faulty CPU and memory installed apparatus to another normal CPU and memory installed apparatus hereby to continue system operation.

10. A computer system according to claim 9, wherein an active one of the CPU and memory installed apparatus which is using another input/output control apparatus is used as said other normal CPU and memory installed apparatus.

11. A computer system according to claim 9, further comprising a backup CPU and memory installed apparatus, said backup CPU and memory installed apparatus being used as said other normal CPU and memory installed apparatus.

12. A computer system according to claim 2, further comprising at least one backup input/output control apparatus, and means for, when either active one of said input/output control apparatus fails to operate due to a fault, assigning said backup input/output control apparatus to said CPU and memory installed apparatus which has been using the faulty input/output control apparatus thereby to continue system operation.

13. A computer system comprising a CPU and memory installed apparatus having at least one CPU and at least one memory, an input/output control apparatus, and a communication cable connecting said CPU and memory installed apparatus and said input/output control apparatus to each other, said CPU and memory installed apparatus having communication means for transmitting an input/output instruction issued by said CPU to said input/output control apparatus via said communication cable, and receiving a response from said input/output control apparatus via said communication cable, and said input/output control apparatus having communication means for receiving an input/output instruction from said CPU and memory installed apparatus via said communication cable, and transmitting a response to said input/output instruction to said CPU and memory installed apparatus via said communication cable.

14. A CPU and memory installed apparatus comprising at least one CPU and at least one memory, communication means for communicating with an external circuit, transmitting an input/output instruction issued by said CPU to an input/output control apparatus which has been assigned in advance, and receiving a response from said input/output control apparatus, and a single board on which said CPU, said memory, and said communication means are mounted.

15. A CPU and memory installed apparatus according to claim 14, wherein said communication means has means for receiving said response as being effective only when the source of the received response is the input/output control apparatus which has been assigned in advance.

16. An input/output control apparatus comprising an input/output control circuit for controlling a peripheral device based on an input/output instruction, communication means for communicating with an external circuit, receiving an input/output instruction from a CPU and memory installed apparatus which has been set in advance and transferring said input/output instruction to said input/output control circuit, and transmitting a response to said input/output instruction to said CPU and memory installed apparatus.

17. An input/output control apparatus according to claim 16, wherein said communication means has means for receiving said input/output instruction as being effective only when the source of the received input/output instruction is the CPU and memory installed apparatus which has been set in advance.
